(19) United States
(12) Patent Application Publication
(10) Pub. No.: US 2011/0154699 A1
(43) Pub. Date: Jun. 30, 2011

(54) Preprinted Roll-On Shrink-On Label

(75) Inventors: John Walsh, Medina, OH (US); Charles K. Herrmann, Shaker Heights, OH (US); Dirk Lovelace, Spartansburg, SC (US); Robert Morris, Simpsonville, OH (US); Dennis Rene Benoit, Simpsonville, OH (US)

(73) Assignee: AVERY DENNISON CORPORATION, Pasadena, CA (US)

(21) Appl. No.: 12/849,047

(22) Filed: Aug. 3, 2010

Related U.S. Application Data
(60) Provisional application No. 61/230,767, filed on Aug. 3, 2009.

(51) Int. Cl. G09F 3/10; B32B 37/02; B32B 37/14; B32B 37/12; B32B 38/04; B32B 38/10; B32B 38/14; B65C 3/00; G09F 3/02

(52) U.S. Cl. 40/306; 156/86; 40/638

(57) ABSTRACT

The present invention describes a label comprising a shrinkable film material section with a leading end, a trailing end, an upper edge portion and a lower edge portion, where the upper edge portion and the lower edge portions extend between the leading end and the trailing end of the section, wherein the section is wrapped around an article with the leading end secured to the article with a patterned adhesive, and the adhesive is confined to a narrow region of the leading end such that the trailing end overlaps and is secured to the leading end by the patterned adhesive, and the adhesive is also confined to a narrow region of said trailing edge, allowing the section to encircle the article in an initially unshrunken or first condition such that when a catalyst is subsequently applied to the section, the section shrinks around the article and is thus securely adhered to the article by the adhesive at both the leading end and the trailing end of the film section. The section may be comprised of foamed, cellular, or stabilized film and may also include a liner.

### CROSS-REFERENCE TO RELATED APPLICATIONS

This application claims priority from U.S. Provisional Application No. 61/230,767 filed on Aug. 3, 2009, which is incorporated by reference herein in its entirety.

### FIELD OF THE INVENTION

The invention relates generally to a roll on shrink on (ROSO) film that includes a shrinkable film (via a catalyst) with a pattern of adhesive applied to the film. The invention further includes a method for the application of combining, rolling and shrinking the film onto a container or consumer package for labeling and identification purposes. In addition, the film of the presently described invention may be used for advertising and banding opportunities.

### BACKGROUND OF THE DISCLOSURE

Consumer goods, such as soft drinks, juices, or alcoholic beverages, condiments, personal care items and the like, are sold in containers or packages including glass or plastic bottles or cans. In such cases, in order to differentiate products and to improve visibility of the products, it is common to apply printed, shrinkable labels on the outside of the containers.

One method described herein, is to create a sleeve from shrinkable film such that a leading edge of the label is wrapped around a container or package supported by a mandrel or other axle or spindle used to support the work piece and the trailing edge is overlapped over the leading edge such that the edges are allowed to be adhered to each other, thus forming a sleeve. This sleeve is then placed over the container and exposed to a catalyst to shrink the entire sleeve tightly around the container or package. The sleeve may also have an adhesive coating that assists in adhesion of the sleeve to the container after shrinking.

### BRIEF SUMMARY OF THE DISCLOSURE

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The benefit of the instant invention is to eliminate one or more manufacturing steps increasing the affordability and practicality of the invention at issue.

The present invention includes a film that utilizes a catalyst for shrinking an initially unshrunken material film section. A catalyst can include but is not limited to heat, a steam bath, UV rays, a laser, or light or combinations thereof. The film section has a leading end and a trailing end. The section is wrapped around an article, such as a beverage container, with the leading end secured to the article with a patterned adhesive material. The adhesive material is confined to a narrow region of the leading end. The trailing end is overlapped and secured to the leading end by the patterned adhesive material which is confined to a narrow region of the trailing edge. The film section, with the addition of the catalyst, encircles the article in an unshrunken condition such that when the catalyst is applied the catalyst causes shrinking of the section around the article and such that the section is securely adhered to the article by the adhesive material at the leading end and the trailing end of the film.

In one embodiment the adhesive pattern on the leading edge of the film section allows for application to an article, such as a container, to prevent slipping of the film section away from the article requiring labeling, while the trailing edge is being wrapped and overlaps the leading edge. Preferably, the overlap is in the range of 0.01 to about 1.5 inches more preferably from about 0.25 inches to about 0.50 inches.

In another embodiment, the trailing edge of the film section is adhesively attached to the leading edge of the film section prior to applying a catalyst to shrink the film section around the article.

In a further embodiment the film section is comprised of a polymer selected from the family of polyvinyl chloride (PVC), oriented polypropylene (OPP), glycol-modified polyethylene terephthalate (PETG), oriented polystyrene (OPS), biaxially-oriented polypropylene (BOPP), polyethylene (PE), polyethylene-Ethylene vinyl acetate (PE-EVA).

As described in this disclosure, without wishing to limit the presently disclosed embodiments to any particular theory or definition, the term catalyst as used herein may be any form of energy which activates film shrinkage including heat, steam or light or other radiation (e.g. UV, IR) as well as the use of a chemical compound activated by the catalyst with or without a chemical initiator.

In another embodiment the film section is rolled onto the article, adhered and shrunk around the article omitting the step of forming an individual sleeve and placing the sleeve over the article.

In another embodiment the film section is a medium shrinkage unidirectional film along the machine direction allowing for shrinkage in the range of about 10% to 70%. The amount of shrinkage depends on the outer diameter or contour of the container or article being wrapped. If the container has a smaller contour then, less shrinkage of the film is required. Shrink films used in low shrink or smaller contour applications range form about 25% to about 40%; films used in a medium shrink application range from about 40% to about 55%, and films used in a high shrink or higher contour application range from about 55% to about 70%.

In another embodiment the lead edge and the trail edge shrinkage is up to 90% of the total medium shrinkage.

In another embodiment the lead edge and trail edge include patterned adhesives to efficiently optimize adhesion of the lead edge to the article and for the trail edge to adhere to the lead edge.

The adhesive that may be used in connection with the present invention is a pressure sensitive adhesive (PSA), emulsion acrylic, modified acrylic, rubber or water activated adhesives. Other adhesives are of course possible.

In another embodiment the adhesive is an activatable adhesive where the adhesive is activated at the time the lead edge comes in contact with the article by near infrared radiation (NIR), microwave or laser techniques.

In another embodiment the adhesive is an activatable adhesive such that the adhesive is maintained underneath a fracturable coating allowing for the adhesive to be activated by fracturing the coating and exposing the adhesive located underneath the coating.

In another embodiment the film also includes a liner comprised of a low cost carrier material that allows for self-winding of the shrink label. The label with the liner may include graphics and may be used without an adhesive between the liner and the film, eliminating the need for a top surface silicon release system, so that if adhesive is used it can still firmly bond to the top surface of the film for desired adhesion at the overlap of the lead edge and trail edge.

In another embodiment the liner has a butt cut that would eliminate the need for tooling on the label applicator required for self-winding, thus allowing for saving tooling and set-up costs.

In another embodiment, the butt cut is performed in-line during the lamination of the carrier or alternatively as a secondary step in the film making operation.

In another embodiment the adhesive for the printed roll of film is applicable for non-shrink film applications (stabilized films) such as polyethylene terephthalate (PET), biaxially-oriented polypropylene (BOPP), Nylon, polyvinylchloride (PVC) and others.

In another embodiment the film may also be a foamed or cellular shrinkable film such as oriented (foamed or cellular) polystyrene.

In another embodiment the foamed or cellular shrinkable film is insulative.

In a still further embodiment, a method for applying the film is described and includes the following steps:

Providing a machine-directed unidirectional film roll;
a. printing desired information on the film roll;
b. adding a primer and adhesive on the leading and trailing edge of the slit film roll in a desired pattern;
c. slitting or splitting the film roll to the desired height;
d. cutting the film roll to a desired section length larger than the circumference of the article;
e. applying the film section to the article from the back of the film section with the leading edge of the film section contacting and adhering to the article;
f. wrapping the film section around the article circumference either by spinning the article, while mounted on a mandrel, passing the film segment around the article or a combination of both;
g. overlapping the leading edge and adhering the trailing edge (with both edges having a pattern of adhesive) of the heat-shrinkable film segment to the leading edge of the film segment; and
h. exposing the film segment around and adhered to the article to a catalyst causing the heat-shrinkable film segment to shrink around the article in the machine direction from 10% to 70%.

Other features and advantages of the present invention will become apparent to those skilled in the art from the following detailed description. It is to be understood, however, that the detailed description of the various embodiments and specific examples, while indicating preferred and other embodiments of the present invention, are given by way of illustration and not limitation. Many changes and modifications within the scope of the present invention may be made without departing from the spirit thereof, and the invention includes all such modifications.

### BRIEF DESCRIPTION OF THE FIGURES

These, as well as other objects and advantages of this invention, will be more completely understood and appreciated by referring to the following more detailed description of the presently preferred exemplary embodiments of the invention in conjunction with the accompanying drawings, of which:

FIG. 1 is a front view of a label produced in accordance with the present invention showing a leading and trailing end both of which carry a pattern of adhesive;

FIG. 2 provides a label constructed in accordance with the present invention showing a film wrapped around an object, with the trailing edge overlapping the leading edge such that the edges are allowed to be adhered to each;

FIG. 2A provides an intermediate assembly showing the label partially attached to a container;

FIG. 3 is a block diagram showing a method for applying a heat-shrinkable film to an article;

FIG. 4 illustrates a graphical representation of the amount of the shrinkage when applying the process presently disclosed; and

FIG. 5 provides additional film parameters of a film when applying the process presently disclosed.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

The following is a description of a typical shrink-on operation by creating a sleeve to fit over a typical container (article).

The shrinkable film is delivered to the site as rolls. However, it should be understood that cut sheets may also be used and applied using a sheet feeding system. The rolls of film are unwound and printed before moving to a slitting station. In the slitting station the film is slit (either to split the width into several sleeve components or to cut edges. First, splices should be clearly marked with a colored flag on the side of the roll to alert the operators of a splice. Secondly, the total number of splices should be listed on the outside roll tag. Lastly, sufficient tension must be maintained throughout the roll to prevent telescoping or dishing out (loss of tension during a splice). Crushed cores are unacceptable.

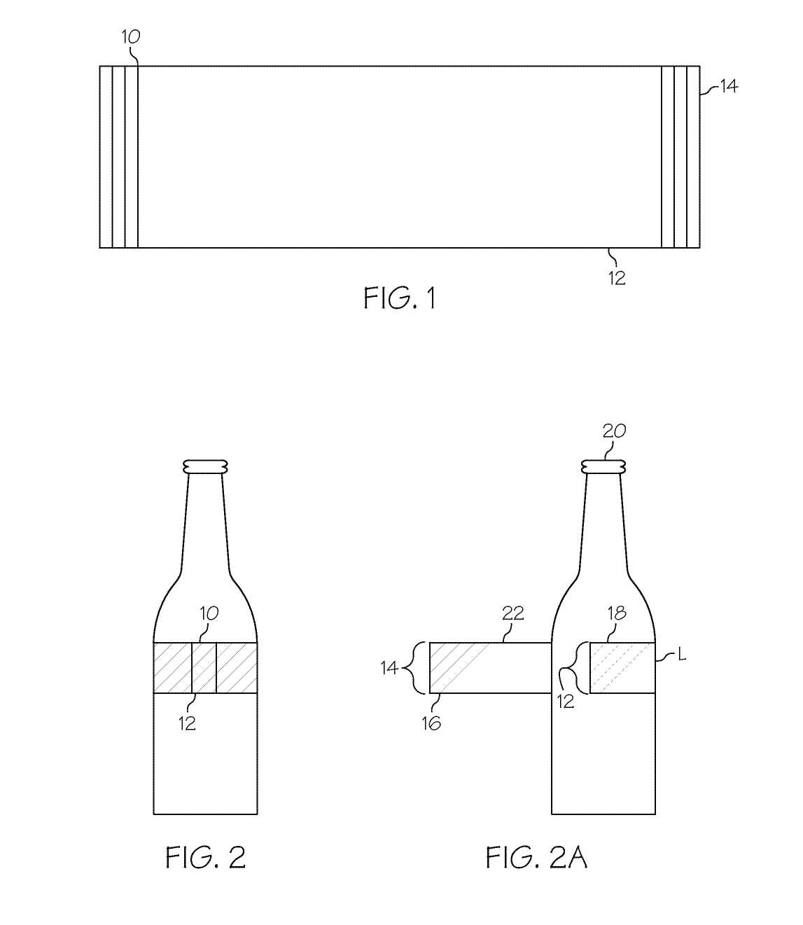

The back of the slit film then has an adhesive applied and wound where it is then transported to a mandrill which shapes the film such that the film forms a sleeve. FIG. 1 illustrates a frontal view of a label generally identified by reference numeral 10. The label 10 has first and second longitudinally extending side edges 15 and 17, respectively and first and second faces 11 and 13. The label 10 further includes a leading edge 12 and a trailing end 14 both or which carry a pattern of adhesive 16 and 18, allowing the two ends to adhere to one another when wrapped around an article, container or package. The sleeve ends overlap each other on the mandrel and are then welded or sealed together. The welded or sealed sleeve then advance to a cutting station where the sleeve is cut to a desired length and fit over the container or article.

Turning now to FIG. 2 a container is generally depicted by reference to numeral 20. The container or article 20 has a sleeve 22 attached to the container 20 by the pattern of adhesive (not shown) on the leading edge 12. The label 22 is then wrapped around the container 20 as the container 20 travels in the machine direction 30 and turns while traveling.

Reference is now directed to FIG. 2A of the presently described invention which illustrates an intermediate assembly for a wrapped container 20. The container 20 with the un-welded sleeve 22, has an area of overlap which is constructed from patterns of adhesive 16 and 18 then passes through some type of catalyst that activates the sleeve 22 to shrink around the container 20. The combination of the adhesive used and the shrinkage of the sleeve allow for securing the film around the container as illustrated by FIG. 2.

FIG. 2 provides a label wrapped around an article, the trailing edge 16 overlapping the leading edge 18. Both edges are adhered to one another.

In the present disclosure, several of the steps outlined above and known in the art have been eliminated, thus making the process more cost effective.

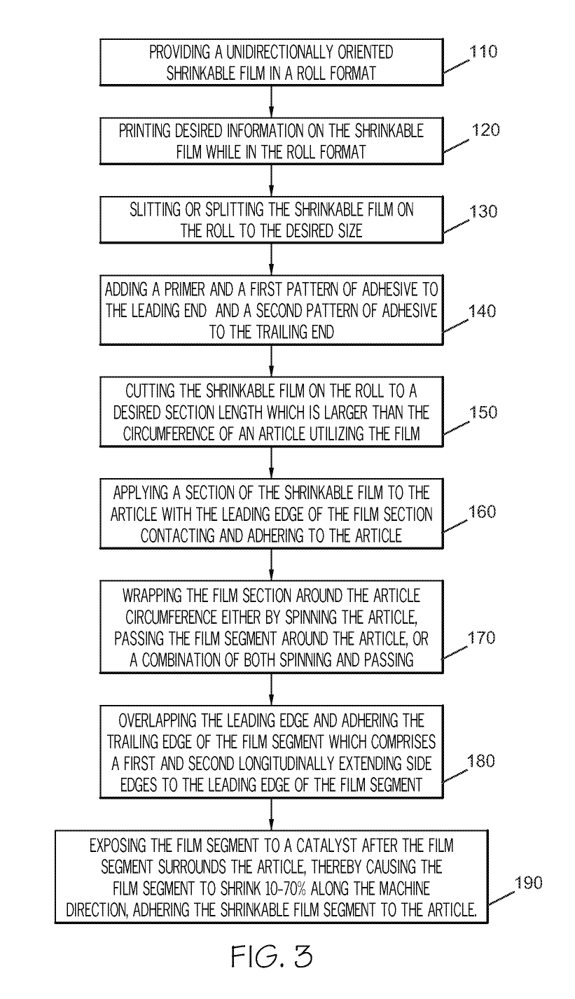

For the present invention, and as illustrated by the block diagram of FIG. 3, the exemplary steps of applying the ROSO film section to the article are:

Providing a machine-directed unidirectional, shrinkable film roll (110);
a. printing desired information on the shrinkable film roll (120);
b. slitting or splitting the shrinkable film roll to the desired height (130);
c. adding a primer and a first pattern of adhesive to the leading end and a second pattern of adhesive to the trailing end (140),
d. cutting the shrinkable film roll to a desired section length larger than the circumference of the article (150);
e. applying the film section to the article from the back of the shrinkable film section with the leading edge of the film section contacting and adhering to the article (160);
f. wrapping the film section around the article circumference either by spinning the article while mounted on a mandrel or independently of the mandrel, passing the shrinkable film segment around the article or a combination of both (170);
g. overlapping the leading edge and adhering the trailing edge of the film segment to the leading edge of the shrinkable film segment allowing the two edges to be attached to one another (180); and
h. exposing the heat shrinkable film segment that is wrapped around and adhered to the article to a catalyst causing the film segment to shrink in the machine direction of between 10 and 70% around the article (190).

The adhesive may serve to temporarily hold the film to the articles when it is initially applied to the article.

The steps of forming a sleeve around a mandrill and fitting the sleeve to the container are eliminated. Additionally, change over to different sized containers is much easier. The mandrill must also be changed. During standard state-of-the-art sleeve application, changes take place in the film width and height cutting as well as the length of the sleeve.

As an optional step, additional printing or the application of graphics or external labels may be applied to the article after the sleeve has been shrunk in place. It should be noted that the printing that occurs in the first step of the foregoing method should be done so as to accommodate the shrinking of the film.

In the present disclosure, the length and width have been changed but there is no mandrill required to replace and adjust during changeover.

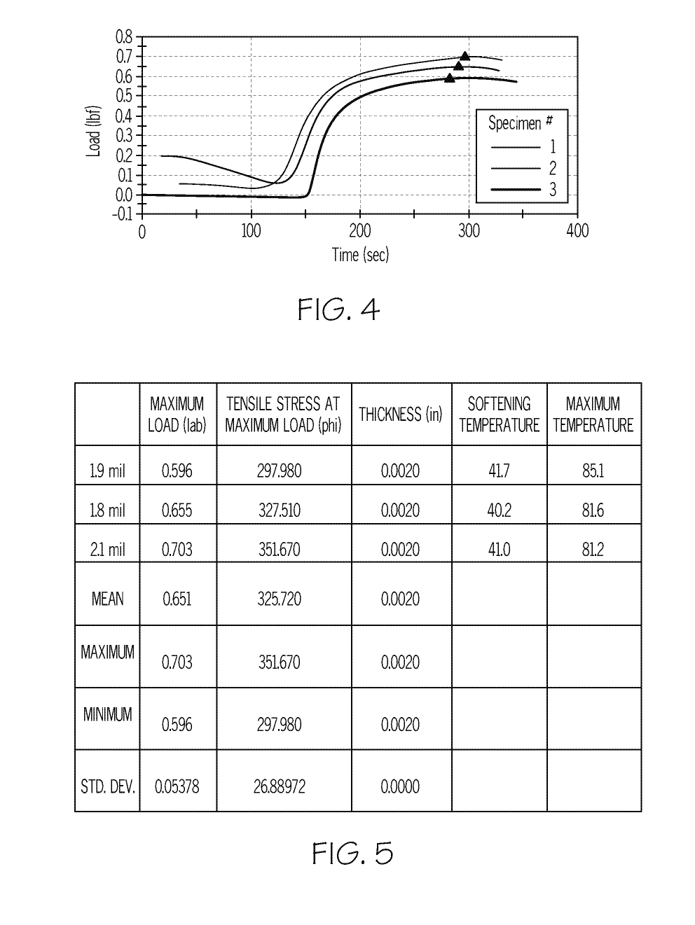

FIG. 4 is a graphical representation of the amount of shrinkage of the film when applying the process of the present disclosure. It was found that the change in the film dimension was—48% in the machine direction and 1.1% in the cross (or perpendicular) direction over time.

FIG. 5 illustrates additional film parameters.

It will thus be seen according to the present invention a highly advantageous ROSO film has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

What is claimed is:

1. A roll on shrink on film comprising
a heat shrinkable film label for wrapping to an object, the film having a leading end and a trailing end, and first and second longitudinally extending side edges, the leading end having a first pattern of adhesive and the trailing end having a second pattern of adhesive, each of the first and second patterns of adhesive is disposed substantially adjacent each of the ends; and
the shrinkable film label having a shrink amount ranging from 10-70% in a machine direction.

2. The film as recited in claim 1, wherein the trailing edge is juxtapositioned over the leading edge such that each of the edges are allowed to be adhered to one another.

3. The film as recited in claim 1 wherein the object is selected from a group including a can, bottle, or other, shaped geometric objects,

4. A roll on shrink on film comprising:
a shrinkable film label,
the film having a leading edge and a trailing edge;
a pattern of adhesive placed on the leading edge and the trailing edge;
an article having first and second ends, and
wherein, the film is applied to the article in a first condition and the article and film is provided with a catalyst to provide a second condition having a shrink amount ranging from 10-70% in a machine direction from the first condition.

5. A film as recited in claim 4, wherein adhesive is confined to a narrow edge of the leading edge and a narrow edge of the trailing edge such that when film is wrapped around the article the leading edge of the film is attached to an article and the trailing edge is attached to a top surface of the leading edge of the film to form a sleeve.

6. A shrink film label, comprising;
a shrinkable film material section, the section comprising a leading end, a trailing end, an upper edge portion and a lower edge portion, the upper edge portion and the lower edge portions extending between the leading end and the trailing end of the section, and the section is wrapped around an article with the leading end secured to the article with a first pattern of adhesive;
the first pattern of adhesive is confined to a narrow region of the leading end such that the trailing end overlaps and is secured to the leading end by a second pattern of adhesive, and wherein the second pattern of adhesive is also confined to a narrow region of the trailing edge; and
wherein the section is allowed to encircle the article in a first condition such that when catalyst is subsequently applied to the section, the section shrinks to a second condition around the article and is securely adhered to the article by the first and second patterns of adhesive at both the leading end and the trailing end of the film section.

7. The film of claim 6, wherein the first adhesive pattern on the leading edge of the film section holds the film section on the article while the trailing edge is wrapped and overlapped with the leading edge.

8. The film of claim 6, wherein the trailing edge of the film section is adhesively attached to the leading edge of the film section before the catalyst is applied to shrink the film section around the article.

9. The film of claim 6, wherein the film section comprises a family of thermoplastics including but not limited to; polyvinylchloride (PVC), oriented polypropylene (OPP), glycol-modified polyethylene terephthalate (PETG), oriented polystyrene (OPS), biaxially-oriented polypropylene (BOPP), polyethylene (PE), polyethylene-ethylene vinyl acetate (PE-EVA)

10. The film of claim 6, wherein the adhesive for a printed roll of film is applicable for non-shrink film applications (stabilized films) including but not limited to; polyethylene terephthalate (PET), biaxially-oriented polypropylene (BOPP), Nylon, and polyvinylchloride (PVC).

11. The film of claim 6, wherein the catalyst includes heat, radiation, chemical composition or combinations thereof.

12. The film of claim 6, wherein the film section is a medium shrinkage, unidirectional film oriented in the machine direction and that shrinks in the range of 10% to 70% in a machine direction.

13. The film of claim 6, wherein the leading edge and the trailing edge of the film provide a total shrinkage of no greater than 90 percent in a machine direction.

14. The film of claim 6, wherein the leading edge and the trailing edge include a patterned adhesive material such that the pattern adheres the leading edge to the article and adheres the trailing edge to the leading edge.

15. The film of claim 6, wherein the adhesive is selected from a group including pressure sensitive adhesive (PSA), emulsion acrylic, modified acrylic, rubber, water activated adhesive or combinations thereof.

16. The film of claim 6, wherein the adhesive is activated by a catalyst selected from a group including heat, near infrared radiation (NIR), microwave, or laser.

17. The film of claim 6, wherein the adhesive is located underneath a fracturable coating and the adhesive is activated by fracturing the coating and exposing the adhesive.

18. The film of claim 6, wherein the film may also include a foamed or cellular shrinkable film.

19. The film of claim 18, wherein the foamed or cellular shrinkable film is insulative.

20. The film of claim 18, wherein the foamed or cellular shrinkable film is a oriented polystyrene.

21. The film of claim 20, wherein the liner has a butt cut.

22. The film of claim 21, wherein the butt cut is performed in-line during the lamination of the carrier or alternatively as a secondary step in the label making process.

23. A method of applying a film to an article comprising the steps of:
a) providing a unidirectionally oriented shrinkable film in a roll format;
b) printing desired information on the shrinkable film while in the roll format;
c) slitting or splitting the shrinkable film on the roll to the desired size;
d) adding a primer and a pattern of adhesive to each of the leading and trailing edges of the slit film on the roll;
e) cutting the shrinkable film on the roll to a desired section length which is larger than the circumference of an article utilizing the film;
f) applying a section of the shrinkable film to the article with the leading edge of the film section contacting and adhering to the article;
g) wrapping the shrinkable film section around the article circumference either by spinning the article, passing the film segment around the article, or a combination of both spinning and passing;
h) overlapping the leading edge and adhering the trailing edge of the shrinkable film segment to the leading edge of the film segment, and
i) exposing the shrinkable film segment to a catalyst after the film segment surrounds the article, thereby causing the film segment to shrink from 10-70% along the machine direction, thereby firmly adhering the film segment to the article.
